(19) United States
(12) Patent Application Publication
(10) Pub. No.: US 2019/0360307 A1
(43) Pub. Date: Nov. 28, 2019

(54) SLOW ROTATING MOTOR POWERED BY PRESSURE PULSING

(71) Applicant: HALLIBURTON ENERGY SERVICES, INC., Houston, TX (US)

(72) Inventors: Robert Pipkin, Marlow, OK (US); Jim B. Surjaatmadja, Duncan, OK (US); Tim Holiman Hunter, Duncan, OK (US)

(21) Appl. No.: 15/775,741

(22) PCT Filed: May 31, 2017
(86) PCT No.: PCT/US2017/035311

§ 371 Date: May 11, 2018

(51) Int. Cl. E21B 37/00; B08B 9/051; F16D 15/00

(52) U.S. Cl. CPC E21B 37/00; F16D 15/00; B08B 9/051

(57) ABSTRACT

Slow-rotating tools may operate within a tubular structure such as casing or tubing strings in a wellbore, e.g., to clean an interior surface of the tubular structure or to support other wellbore applications. A slow-rotating tool may include a nozzle assembly that rotates with respect to an end of a coiled tubing strand or other conveyance, and a working fluid delivered through the conveyance may operate to drive rotation of the nozzle assembly. A motor component of the tool may include a coiled conduit that winds and un-winds in response to pressure fluctuations in the working fluid. The coiled conduit may be operably coupled to a pair of directional clutches that harness the rotational motion induced by the winding and unwinding, and impart the rotational motion to the rotatable housing in a single direction.

### BACKGROUND

The present disclosure relates generally to equipment useful in operations related to oil and gas exploration, drilling and production. More particularly, embodiments of the disclosure relate to downhole tools, pipeline tools or other devices motor systems operable to drive slow rotation of these tools at the end of a conveyance deployed within a wellbore, pipelines or other tubular structure.

There are a number of instances where a tool having the capability of rotation at the end of a conveyance is useful for performing a variety of different downhole or pipeline operations. For example, one such tool may be used to remove the build-up of sediments or other deposits that form on an interior wall of a well casing; tubing, pipeline or other tubular structure, Unless removed, such build-up can plug or restrict flow through the tubular structure. The tool may include a radial aperture or nozzle to expel high-pressure fluid from the tool in a radial direction, Some tools may employ the jet reaction forces to drive rotation of the nozzle. The rotation of these tools is generally uncontrollable, and generally very fast. Thus, these tools have proven generally ineffective in cleaning the hard deposits that exist in well casings, etc.

### BRIEF DESCRIPTION OF THE DRAWINGS

The disclosure is described in detail hereinafter, by way of example only, on the basis of examples represented in the accompanying figures, in which:

FIG. 1 is a partially cross-sectional side view of down-hole coiled tubing system employing an example embodiment slow-rotating tool operating within a wellbore;

FIG. 2 is a perspective view of the slow-rotating tool of FIG. 1 illustrating a nozzle assembly driven by pressure fluctuations in a coiled conduit extending between upper and lower clutch assemblies;

FIG. 3A is a partial perspective view of the upper clutch assembly of FIG. illustrating a plurality of beating races and a one-way clutch mechanism defined between an outer housing and an upper rotor;

FIG. 3B is a cross-sectional view of the one-way clutch mechanism of FIG. 3A illustrating spring loaded plunger and a locking roller;

FIG. 4 is a partial perspective view of the lower clutch assembly of FIG. 2 illustrating a plurality of bearing races, a one-way clutch mechanism and a linear spline;

FIG. 5 is a side view of the nozzle assembly of FIG. 2 illustrating divergent, pressure-fluctuation-generating flow passageways extending to a radial aperture; and

FIG. 6 is a perspective view of another example embodiment of a slow-rotating tool illustrating a coiled conduit extending between a rotationally fixed connector and a dual-directional clutch assembly for driving a nozzle assembly.

### DETAILED DESCRIPTION

The present disclosure includes slow-rotating tools operable within a tubular structure such as casing or tubing strings in a wellbore. By slowly rotating the tool within the tubular structure, the impact force and the exposure time of a fluid jet may be increased to effectively clean hard deposits in a tubular structure. The fluid exiting the tool may be directed in a complete 360° path around the tool while the tool is moved longitudinally through the tubular manner. In this manner, the interior wall of the tubular structure may be effectively cleaned along a length of the tubular structure.

To ensure that the tool rotates slowly, a breaking system may be employed to control the rotational speed of a fluid-driven nozzle. In some breaking systems, friction surfaces and viscous fluids are used to slow the rotation. While these braking systems work, the braking effect may diminish with time as the friction surfaces are worn by abrasives, and/or as viscous fluids heats up and become non-viscous. Other methodologies may be employed to ensure slow rotation. A fluid motor, e.g., a mud motor may be employed in conjunction with a high-reduction, compact transmission to create a reliably slow rotation for fluid jetting.

Embodiments of the slow-rotating tools described herein include a rotatable housing disposed at the end of a coiled tubing strand or other conveyance. A working fluid may be delivered through the conveyance to a motor component of the slow-rotating tool that operates to drive rotation of the rotatable housing. The motor component includes a coiled conduit that twists and un-twists in response to pressure pulses or pressure fluctuations in the working fluid. The coiled conduit may be operably coupled to a pair of directional clutches that harness the rotational motion in the twisting and untwisting, and impart the rotational motion to the rotatable housing in a single direction. In some embodiments, the slow rotating tools include a cleaning tool with a nozzle assembly that generates pressure fluctuations in the working fluid. In some other embodiments, pressure fluctuations may be generated using special rotary on/off valves and the like, and/or pressure fluctuations may be generated by the pumps at surface.

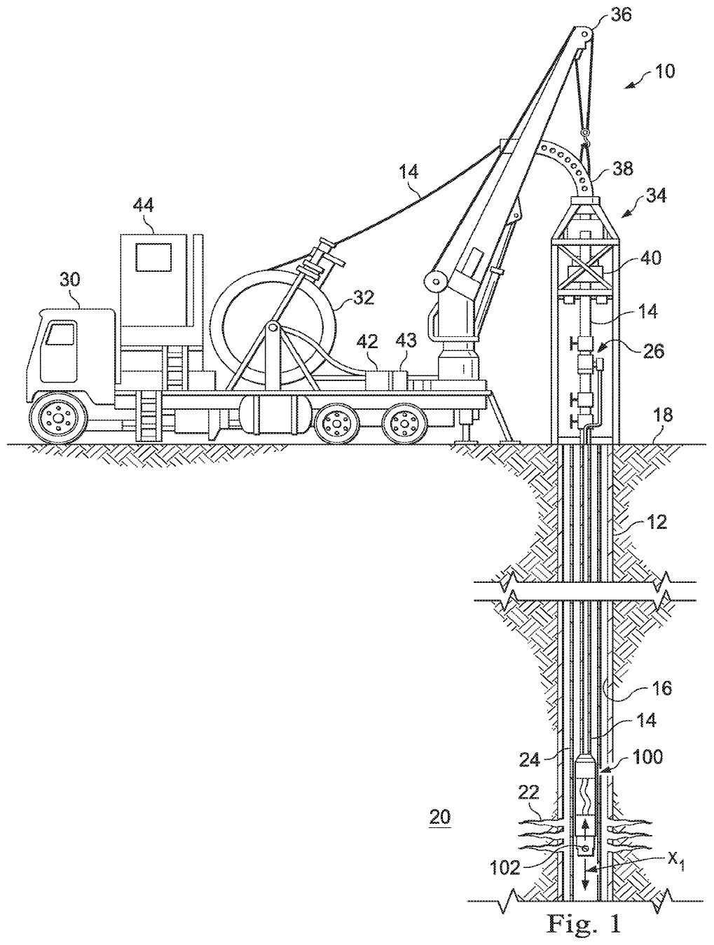

FIG. 1 is a partially cross-sectional side view of a coiled tubing system 10 for deploying a slow-rotating tool 100 in a wellbore 12. The slow-rotating tool 100 is illustrated as being deployed at an end of a coiled tubing strand 14, but in other embodiments (not shown) the slow rotating tool 100 may be deployed at with an alternate conveyance such as drill pipe or other tubular structure. As illustrated herein, the slow-rotating tool 100 is illustrated as a cleaning tool with an aperture 102 arranged to rotate about a longitudinal axis “X₁” to direct fluid at the surrounding wellbore components in a 360° path. In other embodiments, the slow-rotating tool 100 may be operable to rotate for a variety of other wellbore operations, e.g., tool fishing operations.

The wellbore 12 includes a casing string 16 extending from a surface location 18 to a subterranean production zone 20. The casing string 16 includes a plurality of perforations 22 formed in a sidewall thereof to permit the influx of production fluids from the production zone 20 into the wellbore 12 for removal at the surface location 18. A string of production tubing 24 extends from the perforations 22 to a wellhead 26 at the surface location 18. The wellhead 26 includes various valves and other equipment to control the flow of production fluids brought to the surface location through the production tubing 24.

At the surface location 18, the coiled tubing system 10 includes a truck 30 onto which a reel 32 is mounted, and upon the reel 32, a continuous length of the coiled tubing strand 14 is wound. The coiled tubing strand 14 may be constructed of metal, and may be capable of withstanding relatively high pressures. The coiled tubing strand 14 is slightly flexible so as to permit coiling of the coiled tubing strand 14 onto the reel 32. An injector unit 34 is suspended over the wellhead 26 by a hydraulic crane 36 and may be directly attached to the wellhead 26. The injector unit 34 includes a curved guide way 38 and a hydraulic injector 40 for injecting the coiled tubing strand 14 down into the production tubing 24 and for withdrawing the coiled tubing strand 14 from the wellbore 12. As illustrated, a sufficient length of the coiled tubing strand 14 is inserted into the wellbore 12 such that the slow rotating tool 100 coupled to a lower end thereof is disposed at an example target location or other downhole location of interest.

The truck 30 of the coiled tubing system 10 carries a pair of pumps 42. The pumps 42 are fluidly coupled to an upper end of the coiled tubing strand 14 at the center of the reel 32, such that the pumps may be employed to deliver a pressurized working fluid into the coiled tubing strand 14 from a fluid source 43 at the surface location 18. In some embodiments, the source 43 of working fluid may include a mixture of water with cleaning substances (e.g., surfactants, solvents, etc.). Any substance, fluid (liquid and/or gas), material or combination thereof may be included in the fluid source 43 in keeping with the scope of this disclosure. Pumps 42 may be operated from an operator control housing 44 on the truck 30 to deliver the working fluid to the slow rotating tool 100. Alternatively or additionally, pumps 42 may be operated remotely, e.g., from another nearby control housing (not shown), or even remotely through satellite transmission or other communication technologies. The slow rotating tool 100 may, in turn, may expel the working fluid through the aperture 102, e.g., to clean the surrounding production tubing 24. As described in greater detail below, a nozzle assembly 112 (FIG. 5) associated with the aperture 102 may be arranged to generate pressure fluctuations in the working fluid that drive rotation of the nozzle 102 around a 360° path.

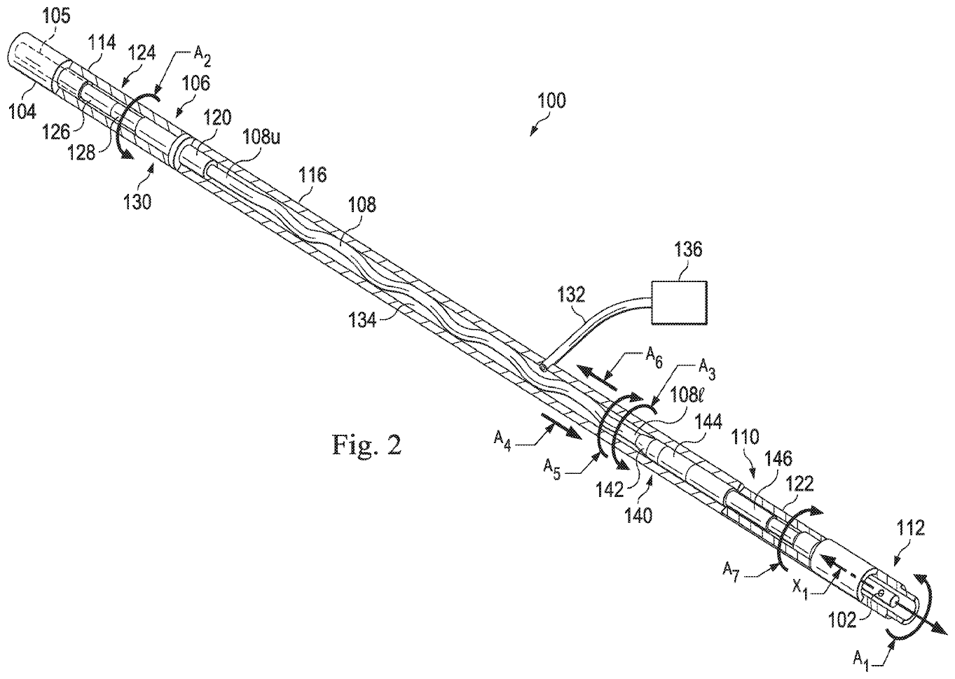

FIG. 2 is a partial perspective view of the slow-rotating tool 100 having portions of the various outer housings removed to illustrate internal portions the slow-rotating tool 100. At an upper end of the slow-rotating tool 100, a conveyance connector such as tubing connector 104 is provided for coupling the slow rotating tool 100 to an end of the coiled tubing strand 14 (FIG. 1). The tubing connector 104 includes an internal passageway 105 through which a working fluid may pass form the coiled tubing strand 14 to the slow rotating tool 100. A fluid passageway is generally defined through the slow-rotating tool 100 extending from the fluid connector 104 through an upper clutch assembly 106, a coiled conduit 108, and a lower clutch assembly 110 and into a nozzle assembly 112. The working fluid may exit the slow rotating tool through the aperture 102 provided in the nozzle assembly 112.

The tubing connector 104 may be coupled to the coiled tubing strand 14 (FIG. 1) in a rotationally fixed manner such that relative rotation therebetween is prohibited. Similarly, an outer housing 114 of the upper clutch assembly 106 may be coupled to the tubing connector 104 in a rotationally fixed manner. An outer housing 116 surrounding the coiled conduit 108, however, may be rotatable with respect to the outer housing 114 of the upper clutch assembly 106, and may be coupled thereto by a thrust bearing 120 such that relative rotation between the outer housings 114, 116 is permitted. The outer housing 116, an outer housing 122 of the lower clutch assembly 110 and the nozzle assembly 112 may be fixedly coupled to one another to rotate together below the thrust beating 120. In this manner, the aperture 102 of the nozzle assembly 112 may be arranged to rotate with respect to the tubing connector 104, e.g., in the direction of arrow A₁. It should be recognized that the slow rotating tool 100 as illustrated and described herein is arranged to cause rotation of the aperture 102 in the direction of A₁, in other embodiments, the aperture 102 may be arranged to rotate in an opposite direction without departing from the scope of the disclosure. It should also be recognized that in some other embodiments, the slow rotating tool 100 may be arranged to cause rotation of other tools for other purposes, e.g., a fishing tool (not shown) for tool fishing purposes.

The upper clutch assembly 106 includes an upper slip connector assembly 124 for accommodating rotational movement within the outer housing 114. The upper slip connector assembly 124 includes an upper member 126 and a lower member 128 that is coupled to the upper member 126 such that rotational motion is permitted therebetween. The upper member 126 may be fixedly coupled to the tubing connector 104 and the lower member 128 may be fixedly coupled to an upper rotor 130 of the of the upper clutch assembly 106. The lower member 128 and the upper rotor 130 may rotate together in the direction of arrow A₂ with respect to the tubing connector 104 and outer housing 114. As described in greater detail below, rotation in a direction opposite arrow A₂ is prohibited. An upper end 108u of the coiled conduit 108 is coupled to, and rotates with, the upper rotor 130 of the upper clutch assembly 106.

The coiled conduit 108 may be constructed of a generally flexible metal or other material, and includes one or more coils defined therein. When there are fluctuations in a pressure differential between an interior and exterior of the coiled conduit 108, a lower end 108l moves rotationally and axially with respect to the outer housing 116. Specifically, when there is a sufficient increase in internal pressure with respect to external pressure, the coiled conduit 108 unwinds causing the lower end 108l to rotate in the direction of arrow A₃ and translate in the direction of arrow A₄ (with respect to the tubing connector 104). When there is a sufficient decrease in the internal pressure with respect to the external pressure, the coiled conduit 108 winds up, causing the lower end 108l to rotate in the direction of arrow A₅ and translate in the direction of arrow A₆.

A pressure control line 132 may extend through the outer housing 116, or otherwise into a sealed chamber 134 defined between the coiled conduit 108 and outer housing 116. The pressure control line 132 may thus facilitate control of the exterior pressure on the coiled conduit 108. In some embodiments, the pressure control line 132 extends to a pressure stable environment such as an annulus defined between casing string 16 (FIG. 1) and production tubing (FIG. 1) such that the pressure in a sealed chamber 134 remains constant. In other embodiments, the pressure control line 132 may extend to an active pressure control device such as pump 136 depicted schematically. The pump 136 may be operated to oscillate the pressure exterior to the coiled conduit 108 (within the sealed chamber 134), and if the pressure on the interior of the coiled conduit 108 is simultaneously maintained at a constant level, the necessary pressure fluctuations to drive rotation of the aperture 102 or other tool may be generated. In other embodiments, the pressure control line 132 may be eliminated and the sealed chamber 134 may maintain a closed volume of fluid therein during operation of coiled conduit 108. Generally, a higher pressure level within sealed chamber 134 may help reduce a strength requirement of the coiled conduit 108; and thus the coiled conduit 108 may be made more responsive to pressure fluctuations. For example, a coiled conduit 108 having relatively high flexibility characteristics may be selected.

The lower end 108E of the coiled conduit 108 may be coupled to the lower clutch assembly 110 by a lower slip connector 140. The lower slip connector assembly 140 includes upper and lower components 142, 144 that are rotatably coupled to one another. The upper component 142 may be fixedly coupled to the lower end 108l of the coiled conduit 108 and the lower component 144 may be fixedly coupled to a lower rotor 146 of the lower clutch assembly 110. As described in greater detail below, the lower component 144 and the lower rotor 146 are arranged to rotate in the direction of arrow A₇ with respect to the outer housing 122, but rotation of in a direction opposite arrow A₇ is prohibited.

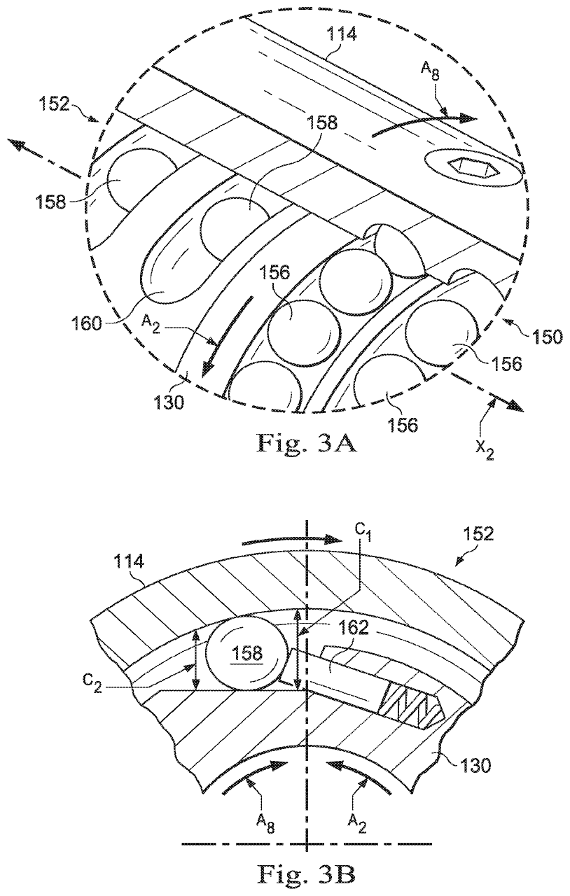

FIG. 3A is a partial perspective view of the upper clutch assembly 106. A plurality of bearing races 150 and a one-way clutch mechanism 152 are defined between the outer housing 114 and the upper rotor 130. A series of ball bearings 156 are provided in the plurality of bearing races 150 and support relative rotation between the outer housing 114 and upper rotor 130 about a longitudinal axis X₂. The one-way clutch mechanism 152 includes a plurality of locking rollers 158 disposed in oblique radial slots 160 defined in the upper rotor 130. The locking rollers 158 are biased outwardly toward the outer housing 114, and operate to permit relative rotation of the upper rotor 130 with respect to the outer housing 114 in the direction of arrow A₂ and to prohibit relative rotation of the upper rotor in the direction of arrows A₈. Locking rollers 158 are illustrated as generally spherical members. In other embodiments, locking rollers (not shown) of other shapes, e.g., cylinders may be employed.

As illustrated in the cross-sectional side view of the upper clutch mechanism 152 of FIG. 3B, the locking rollers 158 are biased by a spring plunger 162 toward the outer housing 114. When there is relative rotation of the upper rotor 130 with respect to the outer housing 114 in the direction of arrow A₂, the outer housing 114 urges the locking rollers 158 inwardly against the bias of the spring plunger 162, thereby providing a sufficient clearance C₁ for the locking roller 158 to roll between the outer housing 114 and the radial slot 160. If any torque provided to the upper rotor 130 in an opposite direction, i.e., in the direction of arrow A₈, then the locking roller 158 is urged toward a region in the radial slot 160 where there is insufficient clearance C₂ to permit rolling of the locking rollers 158. An associated increase in friction will cause the upper rotor 130 to lock up, and thereby prohibit relative rotation between the outer housing 114 and the upper rotor 130. In some instances, the one-way clutch mechanism 152 may be referred to as a “trapped-roller” clutch due in part to the confined nature of the locking rollers 158 between the outer housing 114 and the upper rotor 130.

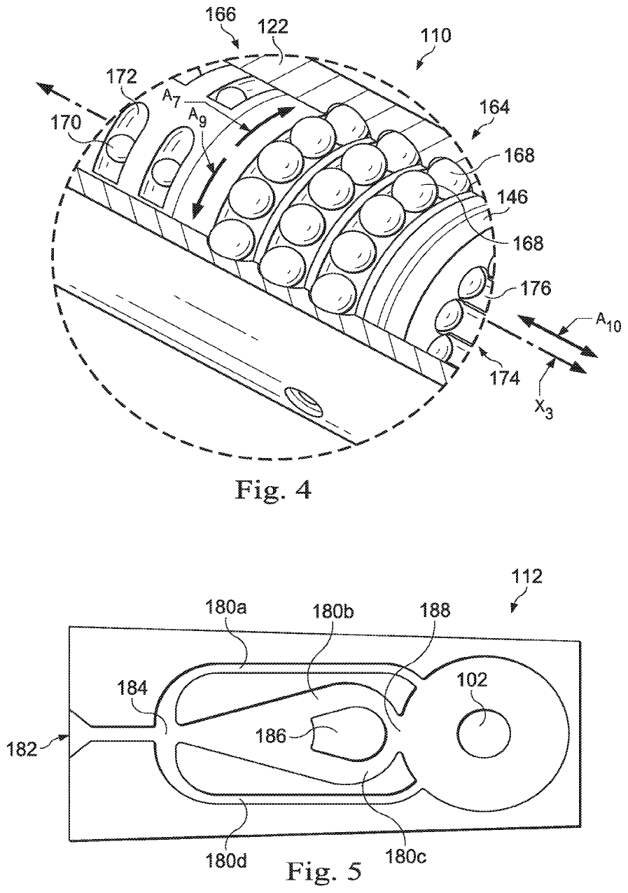

FIG. 4 is a partial perspective view of the lower clutch assembly 110. Similar to the upper clutch assembly of FIG. 3A, a plurality of bearing races 164 and a one-way clutch 166 are defined between the outer housing 122 and the lower rotor 146. A series of ball bearings 168 are provided in the plurality of bearing races 164 and support relative rotation between the outer housing 122 and lower rotor 146 about a longitudinal axis X₃. The one-way clutch 166 operates in a similar manner to the one-way clutch 152 (FIG. 3A) described above, but prohibits rotational motion in an opposite direction. In particular, locking rollers 170 are arranged in oblique radial slots 172 that are oriented in an opposite direction than the oblique radial slots 160. Thus, the one way clutch 168 permits relative rotation of the lower rotor 116 with respect to the outer housing 122 in the direction of arrow A₇ and to prohibits relative rotation in the direction of arrows A₉.

The lower rotor 146 is mounted on a ball spline 174 defined between the lower rotor 146 and a drive shaft 176, The ball spline 174 permits axial motion of the drive shaft 176 with respect to the lower rotor 146 in the direction of arrows A₁₀, and permits the transmission of torque between the drive shaft 176 and the lower rotor 146. The drive shaft 176 may be operably coupled to the lower end 108l of the coiled conduit 108 (FIG. 2) to accommodate the axial motion associated with winding and unwinding of the coiled conduit 108 due to pressure fluctuations in the working fluid.

FIG. 5 is a partial side view of the pressure fluctuation generating nozzle assembly 112. The nozzle assembly 112 includes divergent flow passageways 180a, 180b, 180c and 180d (collectively passageways 180) extending between an inlet 182 and the radial aperture 102. The inlet 182 may be fluidly coupled to the coiled conduit 108 (FIG. 2) to receive pressurized working a fluid therefrom. The working fluid may pass through the passageways 180 and be expelled through the aperture 102, thereby generating pressure fluctuations in the working fluid passing through the coiled conduit 108.

Generally, the nozzle assembly 112 operates by expelling the working fluid as a jet into an upstream chamber 184 toward a flow splitter 186. This flow splitter 186 may include a leading edge directly in the path of the jet. The sides of flow splitter 186 form the inner walls of fluid passageways 180b and 180c, which diverge and around the flow splitter 186 and intersect in a downstream chamber 188, which is defined downstream of the flow splitter 186. The flow passageways 180a, 180d define at least two feedback passageways extending from the downstream chamber 188 back to the upstream chamber 184 on a lateral side of the each of the passageways 180b, 180c.

The jet will cling to one side of the upstream chamber 184 due to a phenomenon called the Coanda effect (the tendency of a fluid jet to stay attached to a convex surface). Thus, the fluid will flow through one of the two fluid pathways 180b or 180c at a time. Flow splitter 186 also helps guide the flow into either fluid pathway 180b or fluid pathway 180c. As the working fluid flows through one fluid passageway such as fluid passageway 180b, feedback fluid passageway 180a will divert a portion of the fluid from downstream chamber 188 and return it to upstream chamber 184. The working fluid will then disturb the fluid flow along the lateral side of the upstream chamber 184 closest to fluid passageway 180b. This disturbance will cause the fluid flow to switch to the side of the upstream chamber 184 closest to fluid pathway 180c. The working fluid will thus flow through fluid passageway 180c, rather than from fluid passageway 180b. Flow through the aperture 102 temporarily ceases for a very short time as the working fluid alternates between fluid passageways 180b and 180c. As a result, the nozzle assembly 112 will generate pulses or pressure fluctuations as the working fluid is discharged in succession into the downstream chamber 188 from the two fluid passageways 180b and 180c, with only one fluid passageways 180b and 180c, ejecting working fluid at a given time. The working fluid is discharged from nozzle assembly 112 through the aperture 102 defined within the downstream chamber 188.

Referring again to FIG. 2, the pressure fluctuations generated by the nozzle assembly 112 operate to wind and unwind the coiled conduit 108, and thereby rotate the nozzle assembly 112, along with the outer housings 122, 116 with respect to the tubing connector 104 and outer housing 114. In other embodiments, pressure fluctuations that drive rotation of the nozzle assembly 112 may be generated from other sources such as the pumps 42 (FIG. 1), and/or pump 136 communicating with the interior or exterior of the coiled conduit 108, respectively. In these embodiments where pressure fluctuations are provided from other sources, the nozzle assembly 112 may be replaced with a conventional jetting assembly that does not generate pressure pulses. The nozzle assembly 112 may also be replaced with other rotating tools, such as fishing tools and the like.

In operation, when the interior pressure of the coiled conduit 108 increases sufficiently with respect to the exterior pressure, the coiled conduit 108 unwinds. Due to the direction of the winding imparted to the coiled conduit 108, unwinding the coiled conduit 108 imparts a torque on the upper rotor in the direction of arrow A₂ and a torque on the lower rotor in the direction of arrow A₃. The torque on the upper rotor 130 may induce rotation of the upper rotor 130 with respect to the outer housing 114 since the upper clutch assembly 106 does not engage in this direction. The upper slip connector assembly 124 operates to prevent this rotation from being transferred to the tubing connector 104. The torque on the lower rotor 146 causes the lower clutch assembly 110 to engage and lock the rotational position of the lower rotor 146 with respect to the outer housing 122. Thus, a torque may be transferred from the lower end 108l of the coiled conduit 108 through the lower slip connector assembly 140, through the drive shaft 176 (FIG. 4), through the lower rotor 146, through the locking rollers 170 (FIG. 4) to the outer housing 122. Since the outer housing 122 may be fixedly coupled to the outer housing 116 and the nozzle assembly 112, the torque is applied to the nozzle assembly 112. Thus, the rotation of lower end 108l of the coiled conduit 108 rotationally couples the coiled conduit 108 to the outer housing 122 and nozzle assembly 112 and induces rotation of the nozzle assembly 112 in the direction of arrow A₁ (along with the outer housings 116, 122) with respect to the tubing connector 104.

When the interior pressure of the coiled conduit 108 is decreased sufficiently with respect to the exterior pressure, the coiled conduit 108 re-winds. The re-winding of the coiled conduit 108 imparts a torque on the upper rotor 130 in the direction opposite of arrow A₂, e.g., in the direction of arrow A₈ (FIG. 3A), and imparts a torque on the lower rotor 146 in the direction of arrow A₇. The torque on the upper rotor 130 induces the upper clutch assembly 106 to engage, thus preventing rotation of the upper end 108u of the coiled conduit 108 with respect to the outer housing 114 and tubing connector 104. The torque on the lower rotor 146 causes the lower clutch assembly 110 to disengage and permit free rotation of the lower end 108l of the coiled conduit 108 with respect to the outer housing 122 and the nozzle assembly 112. Thus, the lower end 108l rotates with respect to the upper end 108u, and the coiled conduit 108 re-winds. Since the lower clutch assembly is disengaged, the torque is not transferred to the outer housing 112 and the nozzle assembly 112 does not rotate in a direction opposite the arrow A₁ in response to rotation of the lower end 108l of the coiled conduit in the direction of arrow A₇.

Since the nozzle assembly 112 does not rotate in response to the re-winding of the coiled conduit 108, there is a net rotation of the nozzle assembly 112 in the direction of arrow A₁ through each winding and re-winding cycle. The size and number of coils or windings in the coiled conduit 108 will affect the amount of rotation that is induced in each cycle. In relatively high frequency applications, e.g., where the nozzle assembly 112 is arranged to generate the pressure fluctuations, a single winding may be provided or four (4) or fewer windings may be provided in the coiled conduit 108 to induce relatively small rotations upon each pressure cycle. In this manner, the nozzle assembly 112 may be rotated relatively slowly in the direction of arrow A₁. In other embodiments where relatively large amplitude pressure fluctuations may be generated, e.g., where the pumps 42 (FIG. 1), and/or pump 136 may generate the pressure fluctuations, a greater number of coils may be provided, e.g., about five (5) or more windings may be provided to induce a relatively large rotation for each pressure cycle.

Also, when pumps 42, 136 are employed to generate pressure fluctuations, rotation in discrete increments may be realized. The pumps 42, 136 could be employed to generate as few as a single pulse having a specific amplitude to impart the desired degree of rotation. For example, the pumping pressure could be varied over a fairly long time to impart a single long-period pressure wave, which would increment the tool one step of rotation (pumping at two alternating pressures to impart rotation as desired). This technique could be employed, e.g., in applications where it may be desirable to replace the nozzle assembly 112 with a nozzle assembly (not shown) that does not generate pressure fluctuations. Operation in this manner places the rotational control at the surface location 18 (FIG. 1), and provides for a fully controllable and infinitely variable rotational system. This method could be employed to induce near-infinitely slow rotation, e.g., for deep jet-cutting applications.

Although the slow-rotating tool 100 is arranged to rotate the nozzle assembly 112 in the direction of arrow Aₜ with respect to the tubing connector, in other embodiments, a slow rotating tool may be provided that rotates a nozzle assembly in a direction opposite arrow A₁. Such a tool may be provided, e.g., by altering the directionality of the clutch assemblies 106, 110, and the directionality of the windings imparted to the coiled conduit 108.

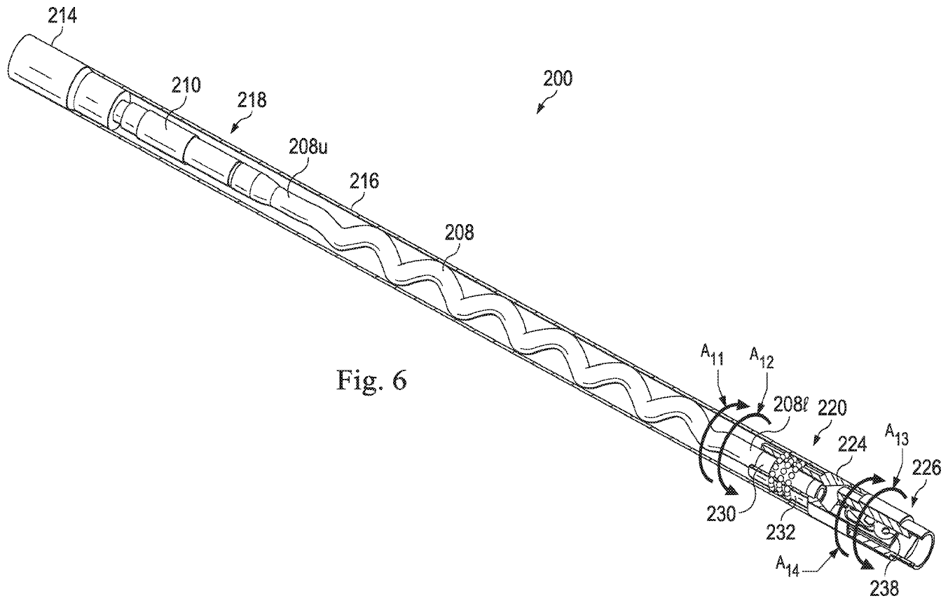

FIG. 6 is a perspective view of another example embodiment of a slow-rotating tool 200 including a coiled conduit 208 extending between a rotationally fixed connector 210 and a dual-directional clutch assembly 212. A conveyance connector such as tubing connector 214 is provided at an upper end of the slow-rotating tool 200 for coupling the slow rotating tool 200 to an end of the coiled tubing strand 14 (FIG. 1) or other conveyance. An outer housing 216 that surrounds the coiled conduit 208 may be fixedly coupled to the tubing connector 214. A double slip connector 218 is also coupled between the tubing connector 214 and an upper end 208u of the coiled conduit 208 and provides strain relief therebetween.

At a lower end of the slow rotating tool 200, the dual-directional clutch assembly 212 includes a plurality of ball bearings in a plurality of bearing races 220. The beating races 220 are defined between the outer housing 216 and a housing member 224 of a nozzle assembly 226, and the ball bearings support rotational motion therebetween. The dual directional clutch assembly 212 also includes a first clutch mechanism 230 defined between a lower end 208l of the coiled conduit 208 and the housing member 224, and a second clutch mechanism 232 defined between the outer housing 216 and the housing member 224 of the nozzle assembly 226. The first and second clutch mechanisms 230, 232 each prohibit relative rotation in a particular direction and permit relative rotation in an opposite direction. In some embodiments, the first clutch mechanism 230 comprises a left-hand sprag clutch that permits rotation of the lower end 208l of the coiled conduit 208 within and housing member 224 in the direction of arrow A₁₁ and prohibits rotation in the direction of arrow A₁₂. The second clutch mechanism 232 may include a tight-hand sprag clutch that that permits rotation of the housing member 224 within the outer housing 216 in the direction of arrow A₁₃ and prohibits rotation in the direction of arrow A₁₄.

The nozzle assembly 226 includes a radial aperture 238 for discharging a working fluid therethrough. The nozzle assembly may be arranged to include a plurality if divergent passageways similar to divergent passageway 180 (FIG. 5) that generate pressure fluctuations in the working fluid as it flows through the coiled conduit 208.

In operation, when there is a sufficient increase in an interior pressure of the coiled conduit 208 with respect to an exterior pressure, the coiled conduit 108 unwinds. The first clutch mechanism 230 engages and the second clutch mechanism 232 disengages. Thus, a torque is transferred from the lower end 208l of the coiled conduit 208 to the housing member 224 through the first clutch mechanism 230, and the second clutch mechanism 232 permits rotation of the housing member 224 within the housing member 216 in the direction of arrow A₁₃. Subsequently, when there is a sufficient decrease in the interior pressure of the coiled conduit 208 with respect to the exterior pressure, the coiled conduit 208 re-winds. The upper clutch mechanism 230 disengages and the lower clutch mechanism 232 engages. Thus, the lower end 208l of the coiled conduit 208 may rotate freely in the direction of arrow A₁₁ while the lower clutch mechanism 232 prevents any counter rotation of the housing member 224 in the direction of arrow A₁₄. Since the upper end 208u, does not rotate with respect to the outer housing 216, the relative rotation of the lower end 208l with respect to the upper end 208u, operates to re-wind the coiled conduit 208.

The pressure fluctuations may be repeated in a series to induce repeated winding and unwinding of the coiled conduit 208. In this manner, the nozzle assembly 226 may be induced to rotate with respect to the tubing connector 214 and the outer housing 208 in the direction of arrow A₁₅.

In some embodiments, a slow rotating tool may be provided with a single one way clutch mechanism. For example, the slow rotating tool 200 illustrated in FIG. 6 may function properly if the lower clutch mechanism 232 was eliminated. As described above, the lower clutch mechanism 232 engages to prevent counter rotation of the housing member 224 in the direction of arrow A₁₄. The bearing races 220 and any seals provided at the lower end of the slow rotating tool 200 may provide sufficient drag between the housing member 224 and the outer housing 216 to sufficiently discourage counter rotation of the housing member 224 in the direction of arrow A₁₄ such that there is a net rotation of nozzle assembly 216 in a single direction. In some embodiments, the lower clutch mechanism 232 may be replaced with a friction element to increase the drag between the housing member 224 and the outer housing 224.

The aspects of the disclosure described below are provided to describe a selection of concepts in a simplified form that are described in greater detail above. This section is not intended to identify key features or essential features of the claimed subject matter, nor is it intended to be used as an aid in determining the scope of the claimed subject matter.

In one aspect, the disclosure is directed to a rotating tool including a conveyance connector operable for coupling the rotating tool to an end of a conveyance. The conveyance connector defines an internal passageway for receiving a working fluid from the conveyance. A coiled conduit is in fluid communication with the internal passageway, and the coiled conduit includes at least one flexible winding therein such that the coiled conduit winds and unwinds in response to pressure fluctuations in the working fluid. A rotatable housing is provided that is rotatable with respect to the conveyance connector. A first clutch mechanism is operably connected to the coiled conduit and to the housing member. The first clutch mechanism is responsive to rotation of the coiled conduit in a first direction to rotationally couple the coiled conduit to the rotatable housing and responsive to rotation of the coiled conduit in a second direction to rotationally decouple the coiled conduit from the rotatable housing.

In one or more embodiments, the rotating tool may further include a second clutch mechanism operably coupled to the coiled conduit. The second clutch mechanism may be responsive to rotation of the coiled conduit in the second direction to permit rotation of a first end of the coiled conduit while a second end of the coiled conduit is rotationally fixed with respect to the conveyance connector. One of the first and second clutch mechanisms may be disposed at the first end of the coiled conduit and the other of the first and second clutch mechanisms is disposed at the second end of the coiled conduit. In some embodiments, the first and second clutch mechanisms are both disposed at a lower end of the coiled conduit. In some example embodiments, at least one of the first and second clutch mechanisms is coupled to the coiled conduit through a linear spline.

In some example embodiments, the first clutch mechanism comprises at least one of the group consisting of a directional clutch, a trapped-roller clutch and a sprag clutch. In some example embodiments, the rotating tool further includes a nozzle assembly operably associated with the rotatable housing, and the nozzle assembly may include a radial aperture arranged to rotate around a longitudinal axis with the rotatable housing in a 360 degree path. In some embodiments, the nozzle assembly includes a plurality of divergent passageways, and the plurality of divergent passageways includes at least two feedback passageways extending from downstream chamber back to an upstream chamber.

In one or more embodiments, a sealed chamber is defined between the coiled conduit and an outer housing surrounding the coiled conduit. In some embodiments, the at least one flexible winding defined in the coiled conduit includes four or fewer windings.

In another aspect, the disclosure is directed to a rotating tool system. The system includes a conveyance operable to deliver a working fluid into a wellbore from a surface location. A conveyance connector is coupled to an end of the conveyance and a coiled conduit is in fluid communication with the conveyance through the conveyance connector. The coiled conduit includes at least one flexible winding therein such that the coiled conduit winds and unwinds in response to pressure fluctuations in the working fluid received therein through the conveyance. A rotatable housing is rotatable with respect to the conveyance connector, and a first clutch mechanism is operably connected to the coiled conduit and to the rotatable housing. The first clutch mechanism is responsive to rotation of the coiled conduit in a first direction to rotationally couple the coiled conduit to the rotatable housing and responsive to rotation of the coiled conduit in a second direction to rotationally decouple the coiled conduit from the rotatable housing.

In one or more embodiments, the conveyance of the rotating tool system includes a coiled tubing strand. In some embodiments, the working fluid comprises a mixture of water with a surfactant or solvent.

In some embodiments, the rotating tool system further includes a pressure fluctuation generator operable for selectively generating pressure fluctuations in the working fluid flowing through the coiled conduit. The pressure fluctuation generator may include at least one of the group consisting of a pump fluidly coupled to an interior of the coiled conduit, a pump fluidly coupled to a sealed chamber defined between the coiled conduit and an outer housing surrounding the coiled conduit, and a nozzle assembly including a plurality of divergent passageways wherein the plurality of divergent passageways includes at least two feedback passageways extending from downstream chamber back to an upstream chamber exterior of the nozzle assembly.

In another aspect, the disclosure is directed to a method of rotating a tool in a wellbore. The method includes (a) conveying a rotatable housing into the wellbore on a conveyance, the rotatable housing rotatably coupled to the conveyance, (b) flowing a working fluid through the conveyance to a coiled conduit coupled to the housing member, (c) generating pressure fluctuations in the working fluid flowing through the coiled conduit to thereby wind and unwind the coiled conduit, (d) rotationally coupling the coiled conduit to the housing member responsive to rotation of the coiled conduit in a first direction, and (e) rotationally decoupling the coiled conduit from the rotatable housing and responsive to rotation of the coiled conduit in a second direction that is opposite the first direction such that there is a net rotation of the housing member in the first direction.

In one or more example embodiments, the method further includes flowing the working fluid through a nozzle assembly that includes a plurality of divergent passageways. The plurality of divergent passageways may include at least two feedback passageways extending from downstream chamber back to an upstream chamber of the nozzle assembly. The method may further include discharging the working fluid from a radial aperture of the nozzle assembly in a complete 360° path around the rotatable housing.

In still another aspect, the disclosure is directed to a rotating tool including a mechanical assembly sensitive to pressure fluctuations. Pressure increases are converted to rotation of the mechanical assembly in a first direction, and pressure decreases are converted to rotation of the mechanical assembly in a second direction opposite the first direction. The mechanical assembly may consist of a coiled conduit, and in some embodiments, the mechanical assembly may be operably coupled to two opposing one-way clutch mechanisms to drive rotation of a connected housing in a singular rotational direction.

The Abstract of the disclosure is solely for providing the United States Patent and Trademark Office and the public at large with a way by which to determine quickly from a cursory reading the nature and gist of technical disclosure, and it represents solely one or more examples.

While various examples have been illustrated in detail, the disclosure is not limited to the examples shown. Modifications and adaptations of the above examples may occur to those skilled in the art. Such modifications and adaptations are in the scope of the disclosure.

What is claimed is:

1. A rotating tool, comprising:
a conveyance connector operable for coupling the rotating tool to an end of a conveyance, the conveyance connector defining an internal passageway for receiving a working fluid from the conveyance;
a coiled conduit in fluid communication with the internal passageway, the coiled conduit including at least one flexible winding therein such that the coiled conduit winds and unwinds in response to pressure fluctuations in the working fluid;
a rotatable housing rotatable with respect to the conveyance connector;
a first clutch mechanism operably connected to the coiled conduit and to the rotatable housing, the first clutch mechanism responsive to rotation of the coiled conduit in a first direction to rotationally couple the coiled conduit to the rotatable housing and responsive to rotation of the coiled conduit in a second direction to rotationally decouple the coiled conduit from the rotatable housing.

2. The rotating tool according to claim 1, further comprising a second clutch mechanism operably coupled to the coiled conduit, the second clutch mechanism responsive to rotation of the coiled conduit in the second direction to permit rotation of a first end of the coiled conduit while a second end of the coiled conduit is rotationally fixed with respect to the conveyance connector.

3. The rotating tool according to claim 2, wherein one of the first and second clutch mechanisms is disposed at the first end of the coiled conduit and the other of the first and second clutch mechanisms is disposed at the second end of the coiled conduit.

4. The rotating tool according to claim 2, wherein the first and second clutch mechanisms are both disposed at a lower end of the coiled conduit.

5. The rotating tool according to claim 2, wherein at least one of the first and second clutch mechanisms is coupled to the coiled conduit through a linear spline.

6. The rotating tool according to claim 1, wherein the first clutch mechanism comprises at least one of the group consisting of a directional clutch, a trapped-roller clutch and a sprag clutch.

7. The rotating tool according to claim 1, further comprising a nozzle assembly operably associated with the rotatable housing, the nozzle assembly including a radial aperture arranged to rotate around a longitudinal axis with the rotatable housing in a 360 degree path.

8. The rotating tool according to claim 7, wherein the nozzle assembly includes a plurality of divergent passageways, and wherein the plurality of divergent passageways includes at least two feedback passageways extending from downstream chamber back to an upstream chamber.

9. The rotating tool according to claim 1, wherein a sealed chamber is defined between the coiled conduit and an outer housing surrounding the coiled conduit.

10. The rotating tool according to claim 1, wherein the at least one flexible winding defined in the coiled conduit includes four or fewer windings.

11. A rotating tool system, comprising:
a conveyance operable to deliver a working fluid into a wellbore from a surface location;
a conveyance connector coupled to air end of the conveyance;
a coiled conduit in fluid communication with the conveyance through the conveyance connector, the coiled conduit including at least one flexible winding therein such that the coiled conduit winds and unwinds in response to pressure fluctuations in the working fluid received therein through the conveyance;
a rotatable housing rotatable with respect to the conveyance connector;
a first clutch mechanism operably connected to the coiled conduit and to the housing member, the first clutch mechanism responsive to rotation of the coiled conduit in a first direction to rotationally couple the coiled conduit to the rotatable housing and responsive to rotation of the coiled conduit in a second direction to rotationally decouple the coiled conduit from the rotatable housing.

12. The system according to claim 11, wherein the conveyance comprises a coiled tubing strand.

13. The system according to claim 11; further comprising a pressure fluctuation generator operable for selectively generating pressure fluctuations in the working fluid flowing through the coiled conduit.

14. The system according to claim 13, wherein the pressure fluctuation generator includes at least one of the group consisting of a pump fluidly coupled to an interior of the coiled conduit, a pump fluidly coupled to a sealed chamber defined between the coiled conduit and an outer housing surrounding the coiled conduit, and a nozzle assembly including a plurality of divergent passageways wherein the plurality of divergent passageways includes at least two feedback passageways extending from downstream chamber back to an upstream chamber exterior of the nozzle assembly.

15. The system according to claim 11, wherein the working fluid comprises a mixture of water with a surfactant or solvent.

16. A method for rotating tool in a wellbore, the method comprising:
conveying a rotatable housing into the wellbore on a conveyance, the rotatable housing rotatably coupled to the conveyance;
flowing a working fluid through the conveyance to a coiled conduit coupled to the rotatable housing;
generating pressure fluctuations in the working fluid flowing through the coiled conduit to thereby wind and unwind the coiled conduit;
rotationally coupling the coiled conduit to the rotatable housing responsive to rotation of the coiled conduit in a first direction; and
rotationally decoupling the coiled conduit from the rotatable housing and responsive to rotation of the coiled conduit in a second direction that is opposite the first direction such that there is a net rotation of the rotatable housing in the first direction.

17. The method according to claim 16, further comprising flowing the working fluid through a nozzle assembly that includes a plurality of divergent passageways, and wherein the plurality of divergent passageways includes at least two feedback passageways extending from downstream chamber back to an upstream chamber of the nozzle assembly.

18. The method according to claim 17, further comprising discharging the working fluid from a radial aperture of the nozzle assembly in a complete 360° path around the rotatable housing.
